(19) United States
(12) Patent Application Publication
(10) Pub. No.: US 2015/0187300 A1
(43) Pub. Date: Jul. 2, 2015

(54) DRIVING CIRCUIT OF LCD PANEL, THE LCD PANEL, AND LCD DEVICE

(71) Applicant: SHENZHEN CHINA STAR OPTOELECTRONICS TECHNOLOGY CO., LTD., Shenzhen, Guangdong (CN)

(72) Inventors: Lei Sun, Shenzhen (CN); Yin-hung Chen, Shenzhen (CN); Xiaoping Tan, Shenzhen (CN); Yu-yeh Chen, Shenzhen (CN)

(21) Appl. No.: 14/236,082

(22) PCT Filed: Jan. 10, 2014
(86) PCT No.: PCT/CN2014/070444

§ 371 Date: Jan. 30, 2014

(30) Foreign Application Priority Data
Dec. 31, 2013 (CN) 201310751786.6

(51) Int. Cl. G09G 3/36; G09G 5/00

(52) U.S. Cl. CPC G09G 3/3648; G09G 5/008

(57) ABSTRACT

A driving circuit of a liquid crystal display (LCD) panel includes a source board directly and electrically connected with an array substrate of the LCD panel. The driving circuit further includes a sequential control unit (TCON), a voltage conversion unit, and a programmable-gamma unit (P-G), where the TCON, the voltage conversion unit, and the P-G are integrated on the source board.

### TECHNICAL FIELD

The present disclosure relates to the field of display screens, and more particularly to a driving circuit of a liquid crystal display (LCD) panel, the LCD panel, and an LCD device.

### BACKGROUND

Printed circuit boards (PCBs) of driving of a liquid crystal display (LCD) panel include a system on chip (SOC) board, a control board (C/B), and a source board. The SOC board generates a video signal, and the control board is mainly used for video signal conversion and to generate a synchronizing signal (a sequential control chip mainly performs the video signal conversion and generates the synchronizing signal). The control board further includes a power source unit (direct current/direct current, DC/DC) and programmable gamma unit (programmable gamma correction buffer circuit chip), where the power unit generates voltages provided for the panel and the sequential control chip. The source board is mainly used to drive a gate/source chip. As market competition of products increases, manufacturers have to reduce production costs.

### SUMMARY

In view of the above-described problems, the aim of the present disclosure is to provide a driving circuit of a liquid crystal display (LCD) panel, the LCD panel, and an LCD device capable of reducing costs.

The aim of the present disclosure is achieved by the following methods.

A driving circuit of a liquid crystal display (LCD) panel comprises a source board directly and electrically connected with an array substrate of the LCD panel. The driving circuit further comprises a sequential control unit (TCON) that converts a video signal and generates a synchronizing signal, a voltage conversion unit, and a programmable-gamma unit (P-G), where the TCON, the voltage conversion unit, and the P-G are integrated on the source board.

Furthermore, the source board comprises a left source board and a right source board, and the left source board and the right source board coupled to each other. The TCON, the voltage conversion unit, and the P-G are arranged on the right source board. The TCON, the voltage conversion unit, and the P-G are arranged on the source board, and the OD is arranged on the SOC, which reduce the placement area of the TCON, and are convenient to make the TCON, the voltage conversion unit, and the P-G directly be arranged on the source board. Thus, the control board is removed, and the costs are reduced, which make the board competitive in the market. The P-G is arranged on the source board to bind the P-G and the LCD panel. If the components arranged on the SOC board appear abnormally, the SOC board only is replaced without adjusting the gamma value of the P-G which reduces labor costs and time.

Furthermore, the source board comprises the left source board and the right source board, and the left source board and the right source board are coupled to each other. The TCON is arranged on the right source board, and the voltage conversion unit and the P-G are arranged on the left source board. The TCON, the voltage conversion unit, and the P-G are arranged on the source board, which allows the control board to be removed, thereby reducing costs and making the board competitive in the market. The TCON is arranged on the XR directly and electrically connected the SOC, and the voltage conversion unit and the P-G are arranged on the XL. Thus, the TCON is effectively coupled to the SOC, and sizes of the XL and the XR is appropriate to the LCD panel, thereby avoiding inconsistent arrangement because one of the left or right source board is greater than the other source board.

Furthermore, the source board comprises the left source board and the right source board, and the left source board and the right source board are coupled to each other. The TCON and the voltage conversion unit are arranged on the right source board, and the P-G is arranged on the left source board. The TCON, the voltage conversion unit, and the P-G are arranged on the source board, which allows the control board to be removed, thereby reducing costs and making the board competitive in the market. Because the P-G mainly generates the gamma voltage correcting a data signal, and the TCON and the voltage conversion unit mainly are used for gate lines and data lines, only the P-G is arranged on the XL. Thus, arrangement of lines is simplified, difficulty of production process reduces, and reduces labor costs and production costs.

Furthermore, the source board comprises the left source board and the right source board, and the left source board and the right source board are coupled to each other. The TCON and the P-G are arranged on the right source board, and the voltage conversion unit is arranged on the left source board. The TCON, the voltage conversion unit, and the P-G are arranged on the source board, which allows the control board to be removed, thereby reducing costs and making the board competitive in the market. The voltage conversion unit generates more heat than other components, and the area of the voltage conversion unit is greater than the areas of the P-G and the TCON without the OD. Thus, only the voltage conversion unit is arranged on the XL, which avoids heat generated by the voltage conversion unit affecting the TCON and the P-GC improves heat dissipation of the voltage conversion unit and makes arrangement reasonable.

A liquid crystal display (LCD) panel comprises a driving circuit of the present disclosure and a system on chip (SOC) board, where the SOC board comprises a system on chip that generates a video signal, and the SOC board is directly and electrically connected with the source board. The TCON, the voltage conversion unit, and the P-G are arranged on the source board, and the SOC board is directly and electrically connected with the source board, which save the control board between the SOC board and the source board, thereby reducing production costs.

Furthermore, the source board comprises a left source board and a right source board. The TCON, the voltage conversion unit, and the P-G are arranged on the right source board or the left source board. The SOC board is electrically connected with the source board via a flexible circuit board, where the flexible circuit board comprises a differential signal line. The TCON, the voltage conversion unit, and the P-G are arranged on the right source board or the left source board, which save cost of one board. The P-G is arranged on the source board to bind the P-G and the LCD panel. If the components arranged on the SOC board appear abnormally, the SOC board only is replaced without adjusting the gamma value of the P-G which reduces labor costs and time.

Furthermore, the SOC board comprises a system on chip that generates a video signal. The driving circuit comprises an over-voltage driving unit that is used to improve reaction efficiency of liquid crystal molecules, and the over-voltage driving unit is arranged on the system on chip. The over-voltage driving unit is configured with a memory chip having storage function, where the memory chip storages a table unit that helps the over-voltage driving unit to improve reaction efficiency of the liquid crystal molecules. The table unit compares a best corresponding response time for the OD and helps the OD to take advantage of the acceleration effect of electric fields. One frame is inserted between two frames, and the LC molecules are applied a high compensating voltage to change arrangement of the liquid crystal molecules in a short time, which makes an image reach the gray scale having a high brightness from the gray scale having a low brightness, thereby improving the response time of the liquid crystal molecules. As placement area of the memory chip is relatively large, the over-voltage driving unit is arranged on the SOC board, which reduces the placement area of the memory chip in the sequential control unit, thus, a packaging area of the sequential control unit is accordingly reduced and placement area of the sequential control unit could be reduced. In addition, one over-voltage driving unit is originally arranged on the sequential control unit and one over-voltage driving unit is originally arranged on the system on chip. In the present disclosure, the two over-voltage driving units are combined together and arranged on the system on chip, according to the need of entire printed board, a reducing area of the sequential control unit is greater than an expanding area of the system on chip. Thus, an area of an entire printed board is reduced and manufacturing costs are reduced.

Furthermore, the TCON is configured with a first high speed low-voltage differential interface, and the SOC board is configured with a second high speed low-voltage differential interface that matches to the first high speed low-voltage differential interface. The first high speed low-voltage differential interface is connected with the second high speed low-voltage differential interface via the differential signal line. At a typical three-dimensional (3D) display mode, a low-voltage differential signal of 60 HZ is input, and a 3D display image of 120 HZ is output via the TCON, which reduces resolution. The present disclosure uses the high speed low-voltage differential interface instead of an original interface of the TCON, when differential lines are constant, a low-voltage differential signal of 120 HZ is input, and the 3D display image of 120 HZ is output, which achieves the 3D display mode without reducing resolution.

A liquid crystal display (LCD) device comprises an LCD panel of the present disclosure, and the LCD device uses the above-mentioned driving circuit, which effectively reduces production costs.

It should be understood, main cost of the driving circuit of the LCD panel is from a circuit board, and a typical LCD panel mainly comprises the SOC board, a control board (C/B), and the source board, where the above-mentioned three boards occupy main production costs. In the present disclosure, the TCON, the DC/DC, and the P-G are arranged on the source board, which removes the typical C/B comprising the TCON, the DC/DC, and the P-G, thereby reducing production costs.

### BRIEF DESCRIPTION OF FIGURES

FIG. 1 is a schematic diagram of a driving circuit of a liquid crystal display (LCD) panel, the LCD panel, and an LCD device of the present disclosure.

FIG. 2 is a schematic diagram of an LCD panel of a first example of the present disclosure.

FIG. 3 is a schematic diagram of an LCD panel of a second example of the present disclosure.

FIG. 4 is a schematic diagram of an LCD panel of a third example of the present disclosure

FIG. 5 is a schematic diagram of an LCD panel of a fourth example of the present disclosure.

### DETAILED DESCRIPTION

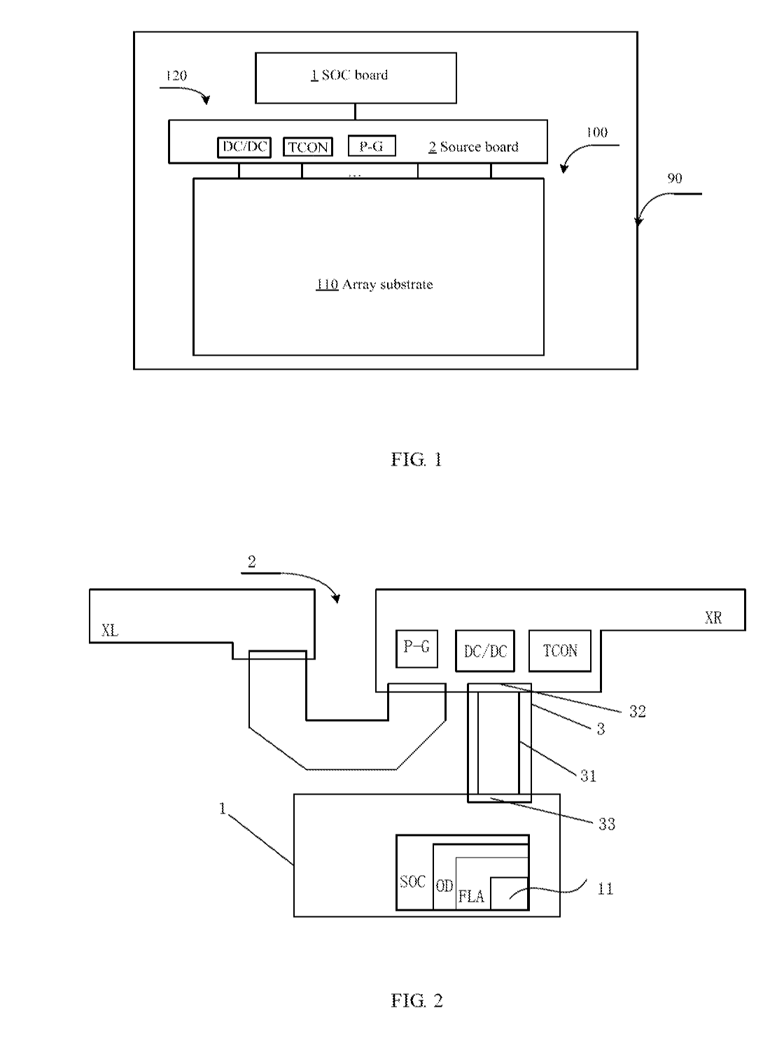

FIG. 1 is a schematic diagram of a driving circuit of a liquid crystal display (LCD) panel, the LCD panel, and an LCD device of the present disclosure, where the LCD device 90 comprises the LCD panel 100 comprising the driving circuit 120, an array substrate 110, and a system on chip (SOC) board 1. The driving circuit 120 comprises a source board 2 directly and electrically connected with the array substrate 110. The driving circuit 120 further comprises a sequential control unit TCON that converts a video signal and generates a synchronizing signal, a voltage conversion unit DC/DC and a programmable-gamma unit P-G that generates a gamma voltage correcting brightness of a gray scale of an image, where the TCON, the P-G, and the DC/DC are integrated on the source board 2.

It should be understood, main cost of the driving circuit of the LCD panel is from a circuit board, and a typical LCD panel mainly comprises the SOC board, a control board (C/B), and the source board, where the above-mentioned three boards occupy main production costs. In the present disclosure, the TCON, the DC/DC, and the P-G are arranged on the source board, which removes the typical C/B comprising the TCON, the DC/DC, and the P-GO thereby reducing production costs.

The present disclosure is further described in detail in accordance with the figures and the exemplary examples.

FIG. 2 is a schematic diagram of the LCD panel of a first example of the present disclosure, where the LCD panel comprises the SOC board 1 that generates the video signal, and the source board 2 that drives data lines of the LCD panel. The SOC board 1 comprises a system on chip (SOC), and the source board 2 comprises a left source board XL, a right source board XR coupled to the XL, and the TCON arranged on the XR. The SOC board 1 directly is electrically connected with the TCON of the XR, and the XR is configured with the voltage conversion unit and the P-G that generates the gamma voltage correcting brightness of the gray scale of the image. The TCON, the voltage conversion unit, and the P-G are arranged on the source board, which only uses the source board instead of using the control board and the source board to reduce production costs. In addition, as different LCD panels have different characteristics, a gamma value of the P-G also is accordingly different, where one LCD panel corresponds to one gamma value of the P-G. When the P-G is arranged on the SOC board, if other components arranged on the SOC board (namely except for the P-G) appear abnormally, the gamma value of the P-G needs to be adjusted again after the SOC board is replaced. When the P-G is arranged on the source board, if the components arranged on the SOC board appear abnormally, the SOC board only is replaced without adjusting the gamma value of the P-G, which reduces labor costs and time.

The above-mentioned system on chip SOC comprises an over-voltage driving unit OD, where the OD is configured with a memory chip FLA having storage function. The memory chip storages a table unit 11 used for helping the OD to improve reaction efficiency of liquid crystal (LC) molecules. The table unit 11 compares a best corresponding response time for the OD and helps the OD to take advantage of the acceleration effect of electric fields. One frame is inserted between two frames, and the LC molecules are applied a high compensating voltage to change arrangement of the LC molecules in a short time, which makes an image reach the gray scale having a high brightness from the gray scale having a low brightness, thereby improving the response time of the liquid crystal molecules. As placement area of the memory chip is relatively large, the over-voltage driving unit is arranged on the SOC board, which reduces the placement area of the memory chip in the sequential control unit, thus, a packaging area of the sequential control unit is accordingly reduced and the placement area of the sequential control unit could be reduced. In addition, one over-voltage driving unit is originally arranged on the sequential control unit and one over-voltage driving unit is originally arranged on the system on chip. In the present disclosure, the two over-voltage driving units are combined together and arranged on the system on chip, according to the need of entire printed board, a reducing area of the sequential control unit is greater than an expanding area of the system on chip. Thus, an area of an entire printed board is reduced and manufacturing costs are reduced.

The SOC board 1 and the right source board XR comprising the sequential control unit TCON are electrically connected via a flexible circuit board 3. The flexible circuit board 3 comprises a differential signal line 31. The TCON is configured with a first high speed low-voltage differential interface 32, and the SOC board 1 is configured with a second high speed low-voltage differential interface 33 that matches to the first high speed low-voltage differential interface 32, where the first high speed low-voltage differential interface 32 is connected with the second high speed low-voltage differential interface 33 via the differential signal line 31. At a typical three-dimensional (3D) display mode, a low-voltage differential signal of 60 HZ is input, and a 3D display image of 120 HZ is output via the TCON, which reduces resolution. The present disclosure uses the high speed low-voltage differential interface instead of an original interface of the TCON, when differential lines are constant, a low-voltage differential signal of 120 HZ is input, and the 3D display image of 120 HZ is output, which achieves the 3D display mode without reducing resolution.

FIG. 3 is a schematic diagram of the LCD panel of a second example of the present disclosure, where the LCD panel comprises the SOC board 1 that generates the video signal, and the source board 2 that drives data lines of the LCD panel. The SOC board 1 comprises the system on chip (SOC), where the SOC comprises the over-voltage driving unit OD configured with the memory chip FLA. The source board 2 comprises the left source board XL, the right source board XR coupled to the XL, and the TCON arranged on the XR. The SOC board 1 is directly and electrically connected with the TCON of the XR. The LCD panel comprises the voltage conversion unit DC/DC and the P-G that generates the gamma voltage correcting brightness of the gray scale of the image, where the voltage conversion unit DC/DC and the P-G are arranged at the left source board XL. The voltage conversion unit, and the P-G are directly arranged on the source board, and the OD is arranged on the SOC, which reduce the placement area of the TCON, and are convenient to make the TCON, the voltage conversion unit, and the P-G directly be arranged on the source board. Thus, the control board is removed, the costs are reduced, which make the board competitive in the market. The P-G is arranged on the source board to bind the gamma value of the P-G and the LCD panel. If the components arranged on the SOC board appear abnormally, the SOC board only is replaced without adjusting the gamma value of the P-G, which reduces labor costs and time. The TCON is arranged on the XR directly and electrically connected the SOC, and the voltage conversion unit and the P-G are arranged on the XL. Thus, the TCON is effectively coupled to the SOC, and sizes of the XL and the XR is appropriate to the LCD panel, thereby avoiding inconsistent arrangement because one of the left or right source board is greater than the other source board.

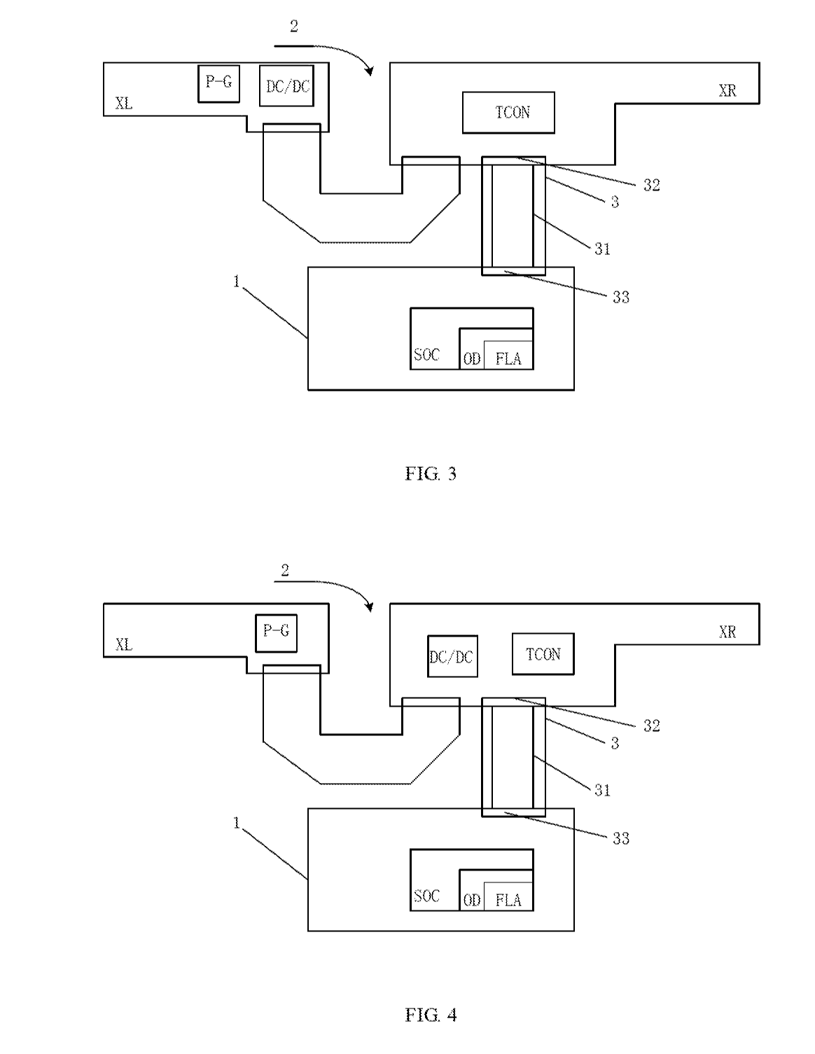

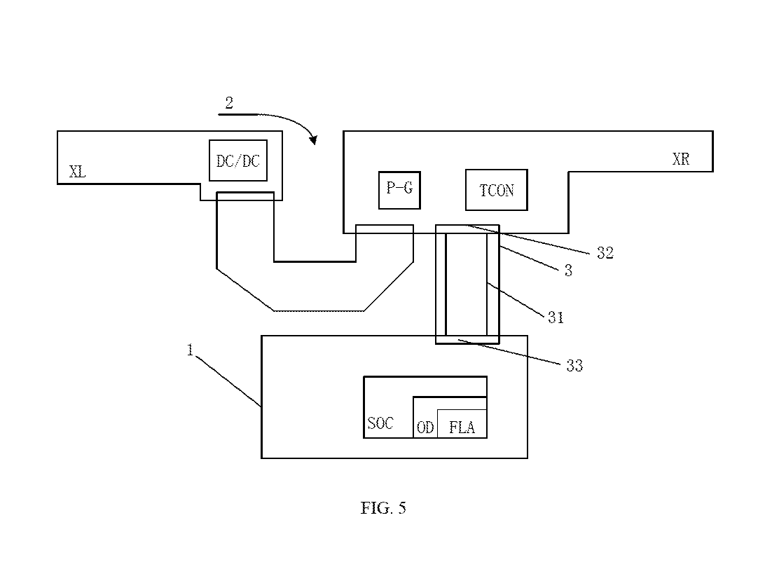

FIG. 4 is a schematic diagram of the LCD panel of a third example of the present disclosure, where the LCD panel comprises the SOC board 1 that generates the video signal, and the source board 2 that drives data lines of the LCD panel. The SOC board 1 comprises the system on chip (SOC), where the SOC comprises the over-voltage driving unit OD configured with the memory chip FLA. The source board 2 comprises the left source board XL, the right source board XR coupled to the XL, and the TCON arranged on the XR. The SOC board 1 is directly and electrically connected with the TCON of the XR. The LCD panel comprises the voltage conversion unit DC/DC and the P-G that generates the gamma voltage correcting brightness of the gray scale of the image, where the P-G is arranged on the XL, and the voltage conversion unit DC/DC is arranged on the XR. The voltage conversion unit, and the P-G are arranged on the source board, and the OD is arranged on the SOC, which reduce the placement area of the TCON, and are convenient to make the TCON, the voltage conversion unit, and the P-G directly be arranged on the source board. Thus, the control board is removed, and the costs are reduced, which make the board competitive in the market. The P-G is arranged on the source board to bind the gamma value of the P-G and the LCD panel. If the components arranged on the SOC board appear abnormally, the SOC board only is replaced without adjusting the gamma value of the P-G which reduces labor costs and time. Because the P-G mainly generates the gamma voltage correcting a data signal, and the TCON and the voltage conversion unit mainly are used for gate lines and data lines, only the P-G is arranged on the XL. Thus, arrangement of lines is simplified, difficulty of production process reduces, and labor costs and production costs reduce.

FIG. 5 is a schematic diagram of the LCD panel of a fourth example of the present disclosure, where the LCD panel comprises the SOC board 1 that generates the video signal, and the source board 2 that drives data lines of the LCD panel. The SOC board 1 comprises the system on chip (SOC), where the SOC comprises the over-voltage driving unit OD configured with the memory chip FLA. The source board 2 comprises the left source board XL, the right source board XR coupled to the XL, and the TCON arranged on the XR. The SOC board 1 is directly and electrically connected with the TCON of the XR. The LCD panel comprises the voltage conversion unit DC/DC and the P-G that generates the gamma voltage correcting brightness of the gray scale of the image. The P-G is arranged on the XL and the voltage conversion unit DC/DC is arranged on the XR. The TCON, the voltage conversion unit, and the P-G are arranged on the source board, and the OD is arranged on the SOC, which reduce the placement area of the TCON, and are convenient to make the TCON, the voltage conversion unit, and the P-G directly be arranged on the source board. Thus, the control board is removed, and the costs are reduced, which make the board competitive in the market. The P-G is arranged on the source board to bind the P-G and the LCD panel. If the components arranged on the SOC board appear abnormally, the SOC board only is replaced without adjusting the gamma value of the P-G, which reduces labor costs and time. The voltage conversion unit generates more heat than other components, and the area of the voltage conversion unit is greater than the areas of the P-G and the TCON without the OD. Thus, only the voltage conversion unit is arranged on the XL, which avoids heat generated by the voltage conversion unit affecting the TCON and the P-G, improves heat dissipation of the voltage conversion unit, and makes arrangement reasonable.

The present disclosure is described in detail in accordance with the above contents with the specific exemplary examples. However, this present disclosure is not limited to the specific examples. For the ordinary technical personnel of the technical field of the present disclosure, on the premise of keeping the conception of the present disclosure, the technical personnel can also make simple deductions or replacements, and all of which should be considered to belong to the protection scope of the present disclosure.

We claim:

1. A driving circuit of a liquid crystal display (LCD) panel, comprising:
a source board directly and electrically connected with an array substrate of the LCD panel;
a sequential control unit (TCON) that converts a video signal and generates a synchronizing signal;
a voltage conversion unit; and
a programmable-gamma unit (P-G);
wherein the TCON, the voltage conversion unit, and the P-G are integrated on the source board.

2. The driving circuit of the LCD panel of claim 1, wherein the source board comprises a left source board and a right source board; the TCON, the voltage conversion unit, and the P-G are arranged on the left source board or the right source board.

3. The driving circuit of the LCD panel of claim 2, wherein the left source board and the right source board are coupled to each other; the TCON, the voltage conversion unit, and the P-G are arranged on the right source board.

4. The driving circuit of the LCD panel of claim 2, wherein the left source board and the right source board are coupled to each other; the TCON is arranged on the right source board, and the voltage conversion unit and the P-G are arranged on the left source board.

5. The driving circuit of the LCD panel of claim 2, wherein the left source board and the right source board are coupled to each other; the TCON and the voltage conversion unit are arranged on the right source board, and the P-G is arranged on the left source board.

6. The driving circuit of the LCD panel of claim 2, wherein the left source board and the right source board are coupled to each other; the TCON and the P-G are arranged on the right source board, and the voltage conversion unit is arranged on the left source board.

7. A liquid crystal display (LCD) panel, comprising:
a driving circuit of the LCD panel; and
a system on chip (SOC) board;
wherein the driving circuit of the LCD panel comprises a source board directly and electrically connected with an array substrate of the LCD panel, a sequential control unit (TCON) that converts a video signal and generates a synchronizing signal, a voltage conversion unit, and a programmable-gamma unit (P-G); the source board comprises a left source board and a right source board; the TCON, the voltage conversion unit, and the P-G are arranged on the left source board or the right source board; the SOC board comprises a system on chip (SOC) that generates the video signal; the SOC board is directly and electrically connected with the source board.

8. The LCD panel of claim 7, wherein the left source board and the right source board are coupled to each other; the sequential control unit (TCON) and the programmable-gamma unit (P-G) are arranged on the right source board, and the voltage conversion unit is arranged on the left source board.

9. The LCD panel of claim 7, wherein the left source board and the right source board are coupled to each other; the TCON, the voltage conversion unit, and the P-G are arranged on the right source board.

10. The LCD panel of claim 7, wherein the left source board and the right source board are coupled to each other; the TCON is arranged on the right source board, and the voltage conversion unit and the P-G are arranged on the left source board.

11. The LCD panel of claim 7, wherein the left source board and the right source board are coupled to each other, the TCON and the voltage conversion unit are arranged on the right source board, and the P-G is arranged on the left source board.

11. (canceled)

12. The LCD panel of claim 7, wherein the driving circuit comprises an over-voltage driving unit that is used to improve reaction efficiency of liquid crystal molecules, the over-voltage driving unit is arranged on the system on chip:
the over-voltage driving unit is configured with a memory chip having storage function; the memory chip storages a table unit that helps the over-voltage driving unit to improve reaction efficiency of the liquid crystal molecules.

13. The LCD panel of claim 7, wherein the SOC board is electrically connected the source board comprising the TCON via a flexible circuit board; the flexible circuit board comprises a differential signal line; the TCON is configured with a first high speed low-voltage differential interface, and the SOC board is configured with a second high speed low-voltage differential interface that matches to the first high speed low-voltage differential interface; the first high speed low-voltage differential interface is connected with the second high speed low-voltage differential interface via the differential signal line.

14. A liquid crystal display (LCD) device, comprising:
an LCD panel; and
wherein the LCD panel comprises a driving circuit of the LCD panel and a system on chi, (SOC) board; the driving circuit of the LCD panel comprises a source board directly and electrically connected with an array substrate of the LCD panel, a sequential control unit (TCON) that converts a video signal and generates a synchronizing signal, a voltage conversion unit, and a programmable-gamma unit (P-G); the TCON, the voltage conversion unit, and the P-G are integrated on the source board; the SOC board comprises a system on chip (SOC) that generates the video signal; the SOC board is directly and electrically connected with the source board.
wherein the source board comprises a left source board and a right source board; the sequential control unit (TCON), the voltage conversion unit, and the programmable-gamma unit (P-G) are arranged on the left source board or the right source board.

15. The LCD device of claim 14, wherein the left source board and the right source board are coupled to each other; the TCON, the voltage conversion unit, and the P-G are arranged on the right source board.

16. The LCD device of claim 14, wherein the left source board and the right source board are coupled to each other; the TCON is arranged on the right source board, and the voltage conversion unit and the P-G are arranged on the left source board.

17. The LCD device of claim 14, wherein the left source board and the right source board are coupled to each other; the TCON and the voltage conversion unit are arranged on the right source board, and the P-G is arranged on the left source board.

18. The LCD device of claim 14, wherein the left source board and the right source board are coupled to each other; the TCON and the P-G are arranged on the right source board, and the voltage conversion unit is arranged on the left source board.

19. The LCD device of claim 14, wherein the driving circuit comprises an over-voltage driving unit that is used to improve reaction efficiency of liquid crystal molecules, the over-voltage driving unit is arranged on the system on chip;
the over-voltage driving unit is configured with a memory chip having storage function; the memory chip storages a table unit that helps the over-voltage driving unit to improve reaction efficiency of the liquid crystal molecules

20. The LCD device of claim 14, wherein the SOC board and the source board comprising the TCON are electrically connected via a flexible circuit board; the flexible circuit board comprises a differential signal line; the TCON is configured with a first high speed low-voltage differential interface, and the SOC board is configured with a second high speed low-voltage differential interface that matches to the first high speed low-voltage differential interface; the first high speed low-voltage differential interface is connected with the second high speed low-voltage differential interface via the differential signal line.
